(19) United States
(12) Patent Application Publication
(10) Pub. No.: US 2009/0222614 A1
(43) Pub. Date: Sep. 3, 2009

(54) INFORMATION PROCESSING APPARATUS AND NONVOLATILE SEMICONDUCTOR MEMORY DRIVE

(75) Inventor: Takehiko Kurashige, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/390,269

(22) Filed: Feb. 20, 2009

Related U.S. Application Data
(63) Continuation of application No. PCT/JP2008/070720, filed on Nov. 7, 2008.

(30) Foreign Application Priority Data
Feb. 29, 2008 (JP) 2008-050809

(51) Int. Cl. G06F 12/02; G06F 12/00

(52) U.S. Cl. 711/103; 711/E12.001; 711/E12.008

(57) ABSTRACT

According to one embodiment, an information processing apparatus includes an information processing apparatus main body, and a nonvolatile semiconductor memory drive which is accommodated in the information processing apparatus main body. The nonvolatile semiconductor memory drive includes a nonvolatile semiconductor memory, and a control module configured to control, in accordance with a command from the information processing apparatus main body, a write operation, a read operation and an erase operation of the nonvolatile semiconductor memory, to generate, in every predetermined time period, statistical information relating to the write operation, the read operation and the erase operation of the nonvolatile semiconductor memory, and to store the statistical information, which corresponds to each of a plurality of time periods each having a time length corresponding to the predetermined time period, in a memory area of the nonvolatile semiconductor memory.

### CROSS REFERENCE TO RELATED APPLICATIONS

This is a Continuation Application of PCT Application No. PCT/JP2008/070720, filed Nov. 7, 2008, which was published under PCT Article 21(2) in English.

This application is based upon and claims the benefit of priority from Japanese Patent Application No. 2008-050809, filed Feb. 29, 2008, the entire contents of which are incorporated herein by reference.

### BACKGROUND

1. Field

One embodiment of the present invention relates to an information processing apparatus and a nonvolatile semiconductor memory drive.

2. Description of the Related Art

There are computers which store log data. As an information processing apparatus having such a log data management function, there is known an information processing apparatus which is disclosed, for instance, in Jpn. Pat. Appln. KOKAI Publication No. 2006-113961.

This information processing apparatus stores log information, which includes the content of a user operation and information relating to an occurring event, in association with time information. On the basis of the log information, this information processing apparatus estimates a future operation condition.

In this information processing apparatus, however, in order to check the information of the operation content and the occurring event on the basis of the log information, it is necessary to select necessary information from the log information and to rearrange the selected information. It is thus difficult to easily understand a cause of, e.g. a fault, or an indication of abnormality which would lead to a failure of devices. In addition, each time an event or the like occurs, the data amount of the log information increases. Consequently, a great amount of memory is necessary for storing log information. It is thus required to realize a novel function for easily rearranging and analyzing information which is to be monitored.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing the external appearance of an information processing apparatus according to an embodiment of the present invention;

FIG. 2 is a block diagram which schematically shows the structure of the information processing apparatus according to the embodiment;

FIG. 3 is a block diagram which schematically shows the structure of an SSD that is used in the information processing apparatus according to the embodiment;

FIG. 4 schematically shows an example of the memory capacities and memory areas of the SSD shown in FIG. 3;

FIG. 5 schematically shows the structure of a NAND memory which is provided in the SSD shown in FIG. 3;

FIG. 6 shows an example of statistical information which is stored in the NAND memory provided in the SSD shown in FIG. 3;

FIG. 7 schematically shows an example of a storage format of monthly information which is stored in the NAND memory provided in the SSD shown in FIG. 3;

FIG. 8 is a flow chart illustrating an example of the procedure of a monthly information storing process which is executed by the SSD shown in FIG. 3;

FIG. 9 schematically shows another example of the storage format of monthly information which is stored in the NAND memory provided in the SSD shown in FIG. 3; and

FIG. 10 is a flow chart illustrating another example of the procedure of the monthly information storing process which is executed by the SSD shown in FIG. 3.

### DETAILED DESCRIPTION

Various embodiments according to the invention will be described hereinafter with reference to the accompanying drawings. In general, according to one embodiment of the invention, there is provided An information processing apparatus comprising: an information processing apparatus main body; and a nonvolatile semiconductor memory drive which is accommodated in the information processing apparatus main body, the nonvolatile semiconductor memory drive including a nonvolatile semiconductor memory, and a control module configured to control, in accordance with a command from the information processing apparatus main body, a write operation, a read operation and an erase operation of the nonvolatile semiconductor memory, to generate, in every predetermined time period, statistical information relating to the write operation, the read operation and the erase operation of the nonvolatile semiconductor memory, and to store the statistical information, which corresponds to each of a plurality of time periods each having a time length corresponding to the predetermined time period, in a memory area of the nonvolatile semiconductor memory.

According to this information processing apparatus, information which is to be monitored can easily be rearranged and analyzed.

<Structure of the Information Processing Apparatus>

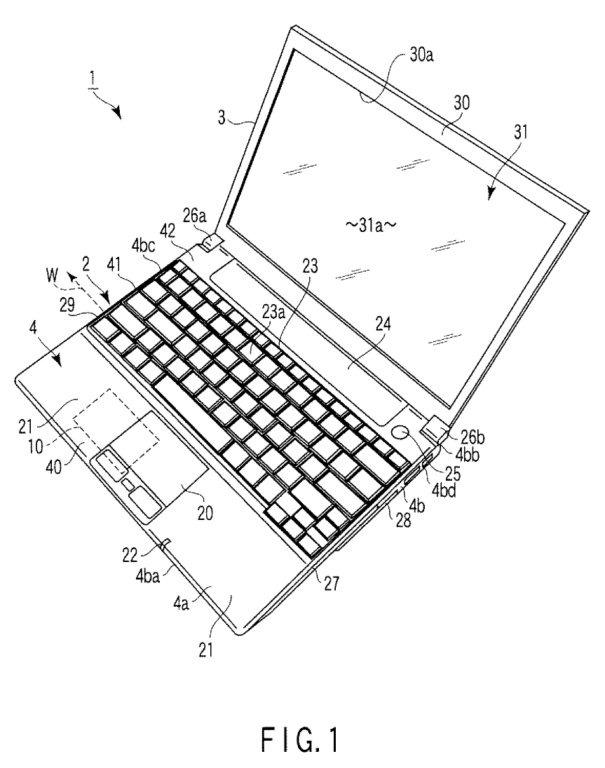

FIG. 1 is a perspective view showing the external appearance of an information processing apparatus according to an embodiment of the present invention. This information processing apparatus 1, as shown in FIG. 1, is composed of an information processing apparatus main body 2 and a display unit 3 which is attached to the information processing apparatus main body 2.

The main body 2 has a box-shaped casing 4. The casing 4 includes an upper wall 4a, a peripheral wall 4b and a lower wall (not shown). The upper wall 4a of the casing 4 includes a front part 40, a central part 41 and a back part 42 in the named order from the side close to a user who operates the information processing apparatus 1. The lower wall is positioned on the side opposite to the upper wall 4a and is opposed to an installation surface on which the information processing apparatus 1 is disposed. The peripheral wall 4b includes a front wall 4ba, a rear wall 4bb and left and right side walls 4bc and 4bd.

The front part 40 includes a touch pad 20 which is a pointing device, a palm rest 21, and an LED 22 which is turned on in association with the operation of respective parts of the information processing apparatus 1.

The central part 41 includes a keyboard mounting part 23 to which a keyboard 23a, which can input character information, etc., is attached.

The back part 42 includes a battery pack 24 which is detachably attached. A power switch 25 for powering on the information processing apparatus 1 is provided on the right side of the battery pack 24. A pair of hinge portions 26a and 26b, which rotatably support the display unit 3, are provided on the left and right sides of the battery pack 24.

An exhaust port 29 for exhausting the wind W to the outside from the inside of the casing 4 is provided on the left side wall 4bc of the casing 4. In addition, an ODD (Optical Disc Drive) 27, which can read and write data on an optical storage medium such as a DVD, and a card slot 28, in/from which various cards can be inserted/taken out, are disposed on the right side wall 4bd.

The casing 4 is formed of a casing cover including a part of the peripheral wall 4b and the upper wall 4a, and a casing base including a part of the peripheral wall 4b and the lower wall. The casing cover is detachably coupled to the casing base, and an accommodation space is formed between the casing cover and the casing base. This accommodation space accommodates, for instance, an SSD (Solid State Drive) 10 functioning as a nonvolatile semiconductor memory drive. The details of the S 10 will be described later.

The display unit 3 includes a display housing 30 having an opening portion 30a, and a display device 31 which is composed of, e.g. an LCD which can display an image on a display screen 31a. The display device 31 is accommodated in the display housing 30, and the display screen 31a is exposed to the outside of the display housing 30 through the opening portion 30a.

The casing 4 accommodates a main circuit board, an expansion module, a fan, etc., which are not shown, in addition to the above-described SSD 10, battery pack 24, ODD 27 and card slot 28.

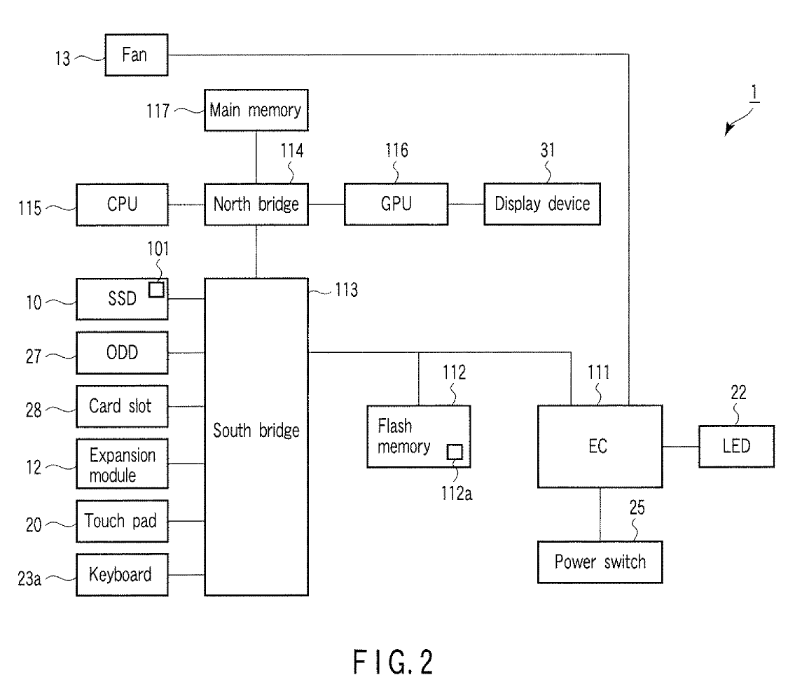

FIG. 2 is a block diagram which schematically shows the system configuration of the information processing apparatus 1.

The information processing apparatus 1, as shown in FIG. 2, includes an EC (Embedded Controller) 111, a flash memory 112 which stores a BIOS (Basic Input Output System) 112a, a south bridge 113, a north bridge 114, a CPU (Central Processing Unit) 115, a GPU (Graphic Processing Unit) 116 and a main memory 117, in addition to the above-described SSD 10, expansion module 12, fan 13, touch pad 20, LED 22, keyboard 23a, power switch 25, ODD 27, card slot 28 and display device 31.

The EC (Embedded Controller) 111 is a built-in system which controls the respective parts. The north bridge 114 is an LSI which controls connection between the CPU 115, CPU 116, main memory 117 and various buses. The CPU 15 is a processor which performs arithmetic processing of various signals, and executes an operating system and various application programs, which are loaded from the SSD 10 into the main memory 117. The GPU 116 is a display controller which executes display control by performing arithmetic processing of a video signal.

The expansion module 12 includes an expansion circuit board, a card socket which is provided on the expansion circuit board, and an expansion module board which is inserted in the card socket. The card socket supports, e.g. the Mini-PCI standard. Examples of the expansion module board include a 3G (3rd Generation) module, a TV tuner, a GPS module, and a Wimax (trademark) module.

The fan 13 is a cooling unit which cools the inside of the casing 4 on the basis of air feeding, and exhausts the air in the casing 4 to the outside as the wind W via the exhaust port 29.

The EC 111, flash memory 112, south bridge 113, north bridge 114, CPU 115, GPU 116 and main memory 117 are electronic components which are mounted on the main circuit board.

<Structure of SSD>

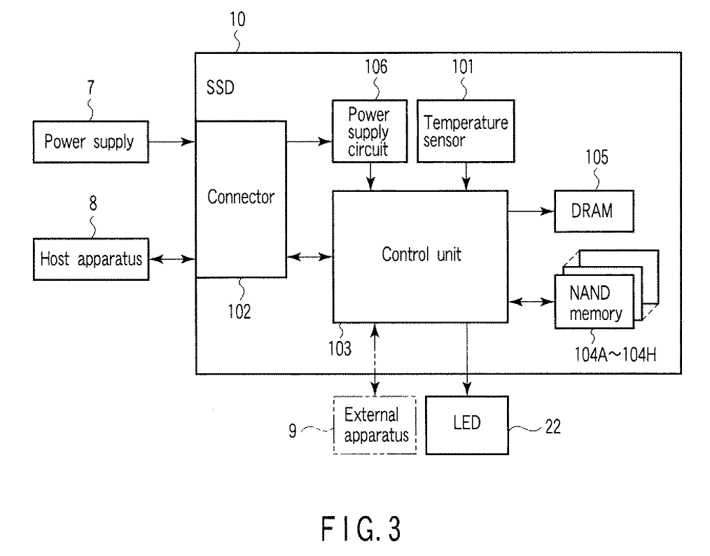

FIG. 3 is a block diagram which schematically shows the structure of the SS that is applied to the information processing apparatus according to the embodiment.

The SSD 10 is a nonvolatile semiconductor memory drive which, in place of a hard disk, is used as an external storage device of the information processing apparatus 1. The SSD 10, as shown in FIG. 3, substantially comprises a temperature sensor 101, a connector 102, a control unit 103, NAND memories (NAND flash EEPROMs) 104A to 104H, a DRAM (memory) 105, and a power supply circuit 106. The SSD 10 is the external storage device which stores data and programs, and the storage content of which is not lost even if no power is supplied. The SSD 10 is a drive which, unlike a hard disk drive, does not have a driving mechanism of a magnetic disk, a head, etc., but the SSD 10 can store programs, such as the OS (Operating System), and data which is created by the user or created on the basis of software, in memory areas of a NAND memory, which is a nonvolatile semiconductor memory, for a long time in a readable/writable manner, and can operate as a boot drive of the information processing apparatus 1.

The control unit 103 is connected to the connector 102, eight NAND memories 104A to 104H, DRAM 105 and power supply circuit 106. In addition, the control unit 103 is connected to the host apparatus 8 via the connector 102, and is connected, where necessary, to an external apparatus 9.

A power supply 7 is the batter pack 24 or an AC adapter (not shown). For example, a power of DC 3.3V is supplied to the power supply circuit 106 via the connector 102. In addition, the power supply 7 supplies power to the entirety of the information processing apparatus 1.

In the present embodiment, the host apparatus 8 is the information processing apparatus main body 2 (the main circuit board of the main body 2). The south bridge 113, which is mounted on the main circuit board, is connected to the control unit 103 via the connector 102. Data transmission/reception is executed between the south bridge 113 and control unit 103, for example, on the basis of the serial ATA standard.

The external apparatus 9 is an information processing apparatus which is different from the information processing apparatus 1. The external apparatus 9 is connected to the control unit 103 of the SSD 10 which is removed from the information processing apparatus 1, for example, on the basis of the RS-232C standard, and the external apparatus 9 has a function of reading out data which is stored in the NAND memories 104A to 104H.

The board, on which the SSD 10 is mounted, has the same outside size as an HDD (Hard Disk Drive) of, e.g. 1.8-inch type or 2.5-inch type. In the present embodiment, this board has the same outside size as the 1.8-inch type HDD.

The control unit 103 is a control module configured to control a write operation, a read operation and an erase operation of the NAND memories 104A to 104H in accordance with a command from the information processing apparatus main body 2. Specifically, in accordance with a request (read command, write command, or other various commands) from the information processing apparatus main body 2 that functions as the host apparatus 8, the control unit 103 controls the execution of data read, write and erase operations on the NAND memories 104A to 104H. The data transfer speed is, for example, 100 MB/Sec at a data read and 40 MB/Sec at a data write.

Each of the NAND memories 104A to 104H is a nonvolatile semiconductor memory having a memory capacity of, e.g. 16 GB. Each of the NAND memories 104A to 104H is composed of, e.g. an MLC (Multi-Level Cell)-NAND memory (multilevel NAND memory) in which 2 bits can be recorded in one memory cell. The MLC-NAND memory has such features that the allowable number of rewrites is smaller than an SLC (Single-Level Cell)-NAND memory, but the memory capacity can be increased more easily than the SLC (Single-Level Cell)-NAND memory.

The DRAM 105 is a buffer which temporarily stores data when data read/write is executed on the NAND memory, 104A to 104H, by the control of the control unit 103.

The connector 102 has a shape based on, e.g. the serial ATA standard. The control unit 103 and power supply circuit 106 may be connected to the host apparatus 8 and power supply 7 via different connectors.

The power supply circuit 106 converts DC 3.3V, which is supplied from the power supply 7, to, e.g. DC 1.8V and 1.2V, and supplies these three kinds of voltages to the respective parts in accordance with the driving voltages of the respective parts of the SSD 10.

<Memory Capacity of SSD>

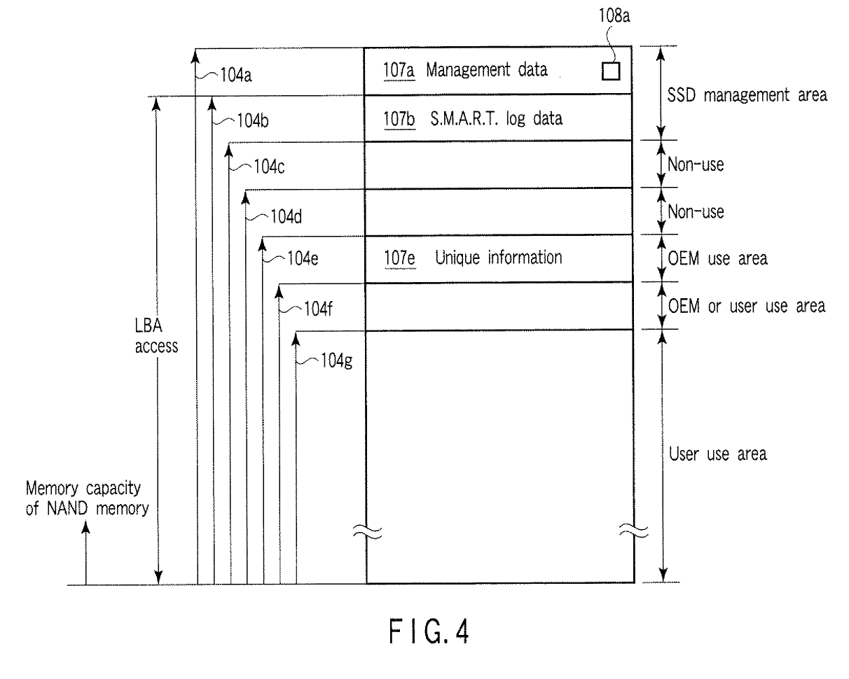

FIG. 4 schematically shows an example of the memory capacities and memory areas of the SSD 10.

The control unit 103 of the SSD 10 manages seven kinds of memory capacities 104a to 104g, which are shown in FIG. 4.

The memory capacity 104a is NAND Capacity, and is a maximum memory capacity using the memory areas of all NAND memories 104A to 104H. Specifically, the memory capacity 104a is the sum of the physical memory capacities of the NAND memories 104A to 104H. For example, if the memory capacity of each of the NAND memories 104A to 104H is 16 GB, the memory capacity 104a is 128 GB. The memory capacity 104a, i.e. the NAND Capacity, is given by, e.g. NAND structure information of a manufacture information write command of a UART (Universal Asynchronous Receiver Transmitter).

The memory capacity 104b is Max Logical Capacity, and is a maximum memory capacity that is accessible by a logical block address (LBA).

The memory capacity 104c is a S.M.A.R.T. log area start LBA, and is provided in order to divide the memory capacity 104b and the memory capacity 104d which will be described below. The S.M.A.R.T. log area start LBA indicates a first LBA of the memory area which stores log data.

The memory capacity 104d is Vender Native Capacity, and is a maximum memory capacity which is given as a user use area. The memory capacity 104d is given by, e.g. initial Identify Device data of an ATA specific command. In addition, the memory capacity 104d is determined by the manufacturer (Vender) at the time of design of the SSD 10 on the basis of the IDEMA (The International Disk Drive Equipment and Materials Association) standard, and is expressed by the following equation:

LBA=97,696,368+(1,953,504×((Capacity in GB)−50)).

The memory capacity 104e is OEM Native Capacity, and is a memory capacity which is determined at the time of manufacture by a request of an OEM (Original Equipment Manufacturer). The memory capacity 104e is given by, e.g. unique information write of an ATA specific command. In addition, the memory capacity 104e is a value which is returned by a Device Configuration Identify command when Device Configuration Overlay Feature Set is supported.

The memory capacity 104f is Native Capacity, and its initial value is equal to the memory capacity 104e. This value can be varied by a Device Configuration Set command when Feature Set is supported. In addition, the memory capacity 104f is a value which is returned by a Read Native Max Address (EXT) command.

The memory capacity 104g is Current Capacity and is a memory capacity during use by the user, and the initial value is equal to the memory capacity 104f. This value can be varied by a SET Max Address command. This value is returned by Word 61:60, and Word 103:100 of an Identify Device command.

The memory areas of the SSD 10 are present between the memory capacities 104a to 104g.

The memory area between the memory capacities 104a and 104b stores management data (management information) 107a for operating the SSD 10, and a logical/physical table 108a for converting each logical block address LBA to a physical address corresponding to a sector which is a memory unit of the NAND memory, 104A to 104H. The logical/physical table 108a indicates the correspondency between the logical block addresses and the physical addresses. Each of the management data 107a and logical/physical table 108 is data which is recorded in fixed areas in the NAND memories 104A to 104H. The LBA is not allocated to each of the management data 107a and logical/physical table 108a. Thus, each of the management data 107a and logical/physical table 108a cannot be accessed, with the LBA being used as a key. The control unit 103 has a fixed access path for accessing each of the management data 107a and logical/physical table 108a, and executes access to each of the management data 107a and logical/physical table 108a via the fixed access path.

The memory area between the memory capacity 104b and memory capacity 104c stores S.M.A.R.T. (Self-Monitoring Analysis and Reporting Technology) log data 107b. The S.M.A.R.T. log data 107b includes, for instance, various statistical information such as temperature information, in addition to event log data. The LBA, which is allocated to the S.M.A.R.T. log data 107b, is locally used in order for firmware, which is executed in the control unit 103, to access the S.M.A.R.T. log data 107b. The firmware, which is executed in the control unit 103, can access the S.M.A.R.T. log data 107b by using the LBA as a key. However, the host apparatus 8 cannot access the S.M.A.R.T. log data 107b by an ordinary read or write command.

In the present embodiment, two kinds of statistical information, namely, lifetime statistical information and monthly statistical information, are used. The lifetime statistical information is information which is collected over the lifetime. On the other hand, the monthly statistical information is statistical information which is collected in every predetermined time period, and statistical information items corresponding to plural time periods are stored in different memory areas. The control unit 103 controls a write operation, a read operation and an erase operation of the NAND memory (NAND memories 104A to 104H), generates, in every predetermined time period, statistical information (monthly statistical information) relating to the write operation, read operation and erase operation of the NAND memory, and stores statistical information items relating to plural time periods (monthly statistical information of plural time periods), which have time lengths each corresponding to the predetermined time period, in memory areas between the memory capacities 104b and 104c. The monthly statistical information is a statistical amount which is obtained by totaling operation conditions of the SSD 10 in every time period, and includes, for example, information relating to each of the numbers of times of write operations, read operations and erase operations of the NAND memory, which are executed in the predetermined time period. Specifically, the monthly statistical Information indicates the number of write commands and the number of read commands, which are received from the information processing apparatus main body 2 in the predetermined time period, and the number of blocks in the NAND memory, which are erased in the predetermined time period.

In the present embodiment, monthly statistical information of the past nine months (or five months) from the present time point is stored. Specifically, the memory area between the memory capacities 104b and 104c is provided with nine monthly statistical data memory areas for storing nine sets of monthly statistical information. The nine monthly statistical data memory areas store monthly statistical information corresponding to a time period one month before, monthly statistical information corresponding to a time period two months before, monthly statistical information corresponding to a time period three months before, monthly statistical information corresponding to a time period four months before, monthly statistical information corresponding to a time period five months before, monthly statistical information corresponding to a time period six months before, monthly statistical information corresponding to a time period seven months before, monthly statistical information corresponding to a time period eight months before, and monthly statistical information corresponding to a time period nine months before.

Further, the control unit 103 generates lifetime statistical information relating to the write operations, read operations and erase operations of the NAND memory, which are executed during the time period from the first activation of the SSD 10 up to the present time point, and stores the generated lifetime statistical information in the memory area between the memory capacities 104b and 104c. The lifetime statistical information is stored in a memory area different from the area in which the monthly statistical information is stored. The lifetime statistical information includes, for example, in addition to temperature statistical information, information relating to the total number of times of each of the write operation, read operation and erase operation of the NAND memory, which are executed from the first activation of the SSD 10 up to the present time point. Specifically, the lifetime statistical information indicates the number of write commands and the number of read commands, which are received from the information processing apparatus main body 2 during the time period from the first activation to the present time point, and the number of blocks in the NAND memory, which are erased during the time period from the first activation to the present time point.

A non-use memory area having a memory capacity of, e.g. 2 MB is set in the memory area between the memory capacities 104c and 104d. The reason for this is that the minimum memory unit of the LBA is 8 sectors, which is a memory unit corresponding to 4 KB (a large memory unit is 1 MB), whereas the actual minimum recording unit of data is 1 sector as a matter of course, and thus the S.M.A.R.T. log data 107b and the data recorded in the memory area equal to or lower than the memory capacity 104d are independently handled by providing an empty memory area with a memory capacity of 1 MB or more.

The memory area between the memory capacity 104d and 104e is a non-use area, and the memory capacity 104d and 104e have the same value except for a particular case.

The memory area between the memory capacities 104e and 104f is a memory area which is used by the OEM. As described above, the unique information 107e, which is determined by the request of the OEM, is written in this memory area.

The memory area between the memory capacities 104f and 104g is a memory area which is used by the OEM or the user. Data write is executed in this memory area by the setting of the OEM or user.

The memory area of the memory capacity 104g is a memory area which is used by the user, and data write is executed in this memory area by the setting of the user.

The memory capacities 104a to 104g satisfy a relationship which is expressed by the following formula:

memory capacity 104a>memory capacity 104b>memory capacity 104c>memory capacity 104d≧memory capacity 104e≧memory capacity 104f≧memory capacity 104g.

At the time of shipment from the manufacturer (Vender), the memory capacities 104d to 104g have the same value.

<Structure of NAND Memory>

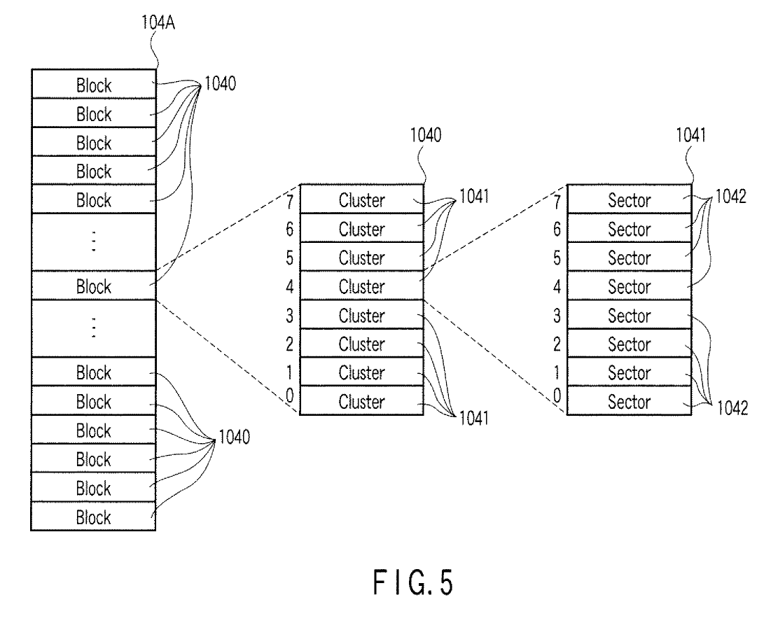

FIG. 5 schematically shows the structure of the NAND memory which is used in the present embodiment. Since the NAND memories 104A to 104H have the same function and structure, a description is given of the NAND memory 104A. The numbers, which are added to the left sides of clusters 1041 and sectors 1042, indicate cluster numbers and sector numbers.

The NAND memory 104A is composed of a plurality of blocks (a plurality of erase blocks) 1040. Each block 1040 is composed of a plurality of clusters, e.g. 1024 clusters 1041. Each cluster 1041 is composed of a predetermined number of sectors, e.g. eight sectors 1042. In the case where each cluster is composed of eight sectors, the data size of each cluster is 4 KB. In the present embodiment, a cluster having a data size of 1 MB is also usable. The data read/write is executed in units of a cluster (in units of a predetermined number of sectors).

<Structure of Statistical Information>

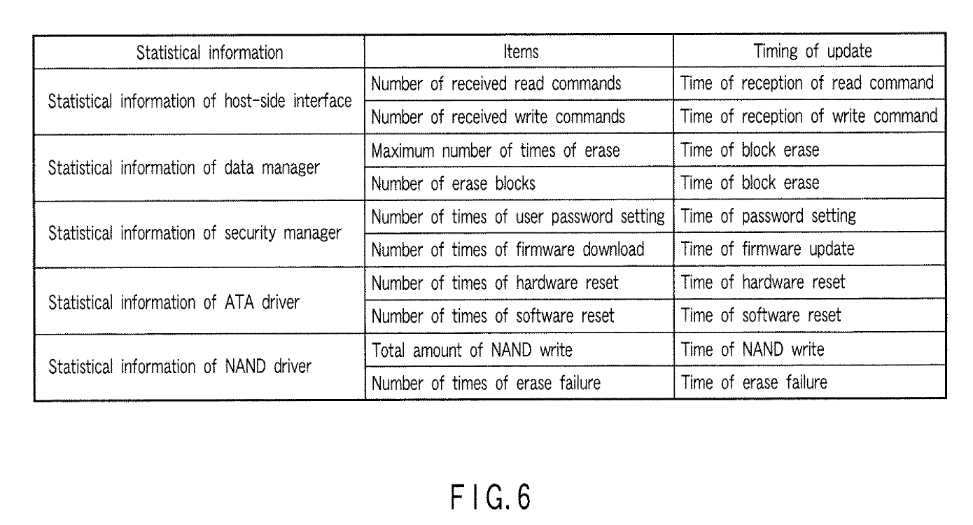

FIG. 6 shows examples of statistical information included in the S.M.A.R.T. log data, the items of the statistical information, and the timings of update. In the SSD 10 according to the present embodiment, as described above, monthly statistical information (hereinafter referred to as “monthly information”) based on the operation condition of the SSD 10, apart from the lifetime statistical information collected over the lifetime from the first activation time, is stored in the S.M.A.R.T. log data 107b shown in FIG. 4.

This monthly information is statistical information which is indicative of the statistical amount relating to the operation condition of the SSD 10. The control unit 103 generates, in every predetermined time period, statistical information (e.g. the number of times of execution) relating to a plurality of predetermined items (e.g. read operation, write operation, erase operation, and wear leveling operation, etc.), and stores the generated statistical information in the memory areas of the NAND memories 104A to 104H. The predetermined time period is a time period which is obtained by dividing the working time of the SSD 10 by a predetermined time. The predetermined time period is, for instance, a period corresponding to one month. Whether the time of one month has passed or not may not always be determined on the basis of the calendar. For example, if the total working time of the SSD 10 has reached 160 hours, it may be determined that the period corresponding to one month has passed. This determination method is based, for example, on the presupposition that the working time of the SSD 10 (the period in which the SSD 10 is powered on) is eight hours per day, and the user uses the SSD 10 for 20 days per month.

In the description below, it is assumed that the monthly information is generated and stored each time the value of an internal counter provided in the control unit 103 reaches a preset value (e.g. a count value corresponding to one month=160 hours). The internal counter counts the time during which the SSD 10 is powered on. By using such an internal counter, the monthly information can be generated and stored, even without providing a clock, such as a read-time clock, in the SSD 10.

The monthly information is composed of, for instance, statistical information relating to a host-side interface, statistical information relating to a data manager, statistical information relating to a security manager, statistical information relating to an ATA driver, and statistical information relating to a NAND driver. Each statistical information is composed of 256 records each comprising 16-byte data.

The statistical information of the host-side interface is, for instance, the number of received read commands, and the number of received write commands. The number of received read commands is indicative of the number of times of reception of the read command from the host apparatus 8 during a predetermined time period. The number of received write commands is indicative of the number of times of reception of the write command from the host apparatus 8 during a predetermined time period. The number of received read commands and the number of received write commands are incremented by (+1), respectively, at update timings which correspond to the time of reception of the read command and the time of reception of the write command.

The statistical information of the data manager is, for instance, the maximum number of times of erase of the NAND memory, and the number of erased blocks. The maximum number of times of erase is indicative of a maximum erase number in all blocks of the NAND memory. The number of erased blocks is indicative of the number of blocks which are erased during a predetermined time period. The update timing of the maximum number of times of erase is the time of block erase. At the time of block erase, it is determined whether the maximum erase number in all blocks is greater than the current value of the maximum number of times of erase. If the maximum erase number in all blocks is greater than the current value of the maximum number of times of erase, the maximum number of times of erase is incremented by +1. The update timing of the number of erase blocks is the time of block erase. At the time of block erase, the number of erase blocks is incremented by +1. The statistical information of the data manager may include a total read data amount (the total number of sectors which are read) during a predetermined time period, and a total write data amount (the total number of sectors which are written) during a predetermined time period.

The statistical information of the security manager is, for instance, the number of times of user password setting, and the number of times of firmware download. The number of times of user password setting is indicative of the number of times of setting of the user password during a predetermined time period. The number of times of firmware download is indicative of the number of times of download of firmware during a predetermined time period. The number of times of user password setting is incremented by (+1) at an update timing which corresponds to the time of user password setting. In addition, the number of times of firmware download is incremented by (+1) at an update timing which corresponds to the time of firmware update.

The statistical information of the ATA driver is, for instance, the number of times of hardware reset, and the number of times of software reset. The number of times of hardware reset is incremented by (+1) at an update timing which corresponds to the time of hardware reset. The number of times of software reset is incremented by (+1) at an update timing which corresponds to the time of software reset.

The statistical information of the NAND driver is, for instance, the total amount of NAND write and the number of times of erase failure. The total amount of NAND write is added to the current value at an update timing which corresponds to the time of NAND write. The number of times of erase failure is incremented by (+1) at an update timing which corresponds to the time of erase failure.

<Operation>

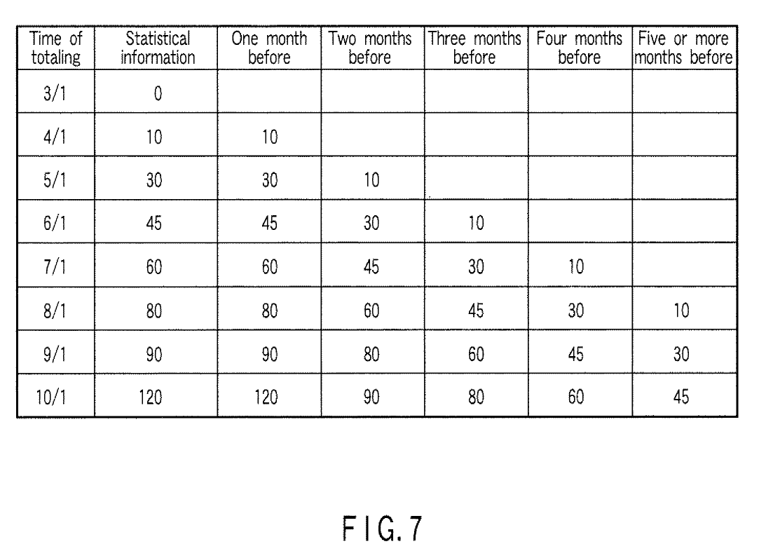

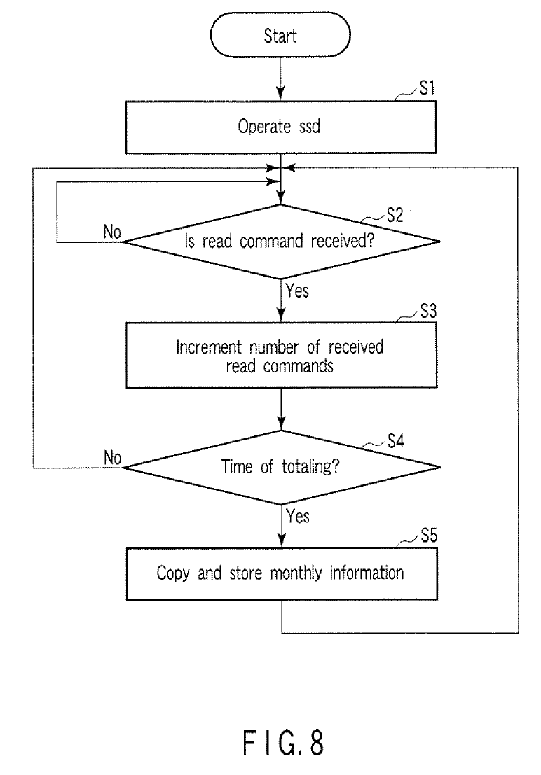

FIG. 7 schematically shows an example of the content of stored monthly information, and FIG. 8 is a flow chart showing the procedure of storing monthly information. The operation of storing monthly information will now be described with reference to the drawings. A description is given of the procedure of creating monthly information in every month with respect to the number of received read commands, which is the above-described statistical information of the host-side interface. The matrix of numerical values shown in FIG. 7 indicates monthly information which is stored in units of a month in the NAND memory, 104A to 104H. In FIG. 7, it is assumed that the monthly information for five months is stored. In the NAND memory, there are prepared five monthly information memory areas which correspond, respectively, to monthly information one month before, monthly information two months before, monthly information three months before, monthly information four months before, and monthly information five or more months before.

If the SSD 10 starts operating on March 1 (step S1), the control unit 103 increments the number of received read commands (step S3) each time a read command is received (step S2: Yes). When April 1, which is one month after, and is a time of totaling, has come (step S4: Yes), the number of received read commands at that time point, for instance, “10”, is copied and stored as monthly information in the area corresponding to one month before (step S5).

Specifically, the control unit 103 starts monitoring the number of received read commands from March 1, and counts the number of read commands that are received from the host apparatus 8. When April 1 has come, to be more specific, if the total working time of the SSD 10 from the first activation time (March 1) has reached 160 hours, the control unit 103 acquires a count value of the number of received read commands, generates monthly information including this count value (“10”), and stores the generated monthly information in the memory area which is prepared in the NAND memory and which corresponds to monthly information one month before.

The control unit 103 repeats the above-described process of steps S2 to S4. If May 1, which is two months after, has come (S4: Yes), the control unit 103 stores the number of received read commands, e.g. “30”, as monthly information in the area corresponding to one month before, and stores the number of received read commands, “10”, in the area corresponding to two months before (step S5).

Specifically, the control unit 103 starts monitoring the number of received read commands from March 1, and counts the number of read commands that are received from the host apparatus 8. When May 1 has come, to be more specific, if the total working time of the SSD 10 from the previous generation of monthly information has reached 160 hours, the control unit 103 acquires once again a count value of the number of received read commands, and generates monthly information including this count value (“30”). The control unit 103 shifts the monthly information (“10”), which is already stored in the memory area corresponding to monthly information one month before, to the memory area corresponding to monthly information two months before, and stores the generated monthly information (“30”) in the memory area corresponding to monthly information one month before.

Subsequently, the above-described operation is repeated at each time of totaling, that is, at predetermined time intervals.

As described above, the monthly information is stored in the NAND memory, 104A to 104H, in a time-sequential manner at the time of totaling, and thereby the operation history in each predetermined time interval can easily and quickly be understood with respect to the number of received read commands. Further, the stored monthly information is read out of the SSD 10 by using the application which operates on the basis of the operation of the information processing apparatus 1, and an arithmetic operation is executed by the CPU 115 of the information processing apparatus 1. Thereby, creation of data, such as histograms, can easily be made, and an output, such as screen display, can easily be performed. As regards the creation of monthly information, the description has been given of the case in which the predetermined period is invariable. Alternatively, the interval between the previous time of totaling and the time of next totaling may be adjusted in accordance with the operation condition of the SSD 10.

Besides, the monthly information, which is stored in the NAND memory, 104A to 104H, may be read out of the SSD 10 by a device which is connected to the outside via the information processing apparatus 1. In this case, the operation history of the SSD 10 in the predetermined time period can be understood in the state in which the SSD 10 is accommodated in the main body of the information processing apparatus 1.

In the above-described example of the monthly information acquisition method, the description has been given of the case in which the count value of the number of received read commands is not cleared in every month. Alternatively, the count value of the number of received read commands may be cleared in every month.

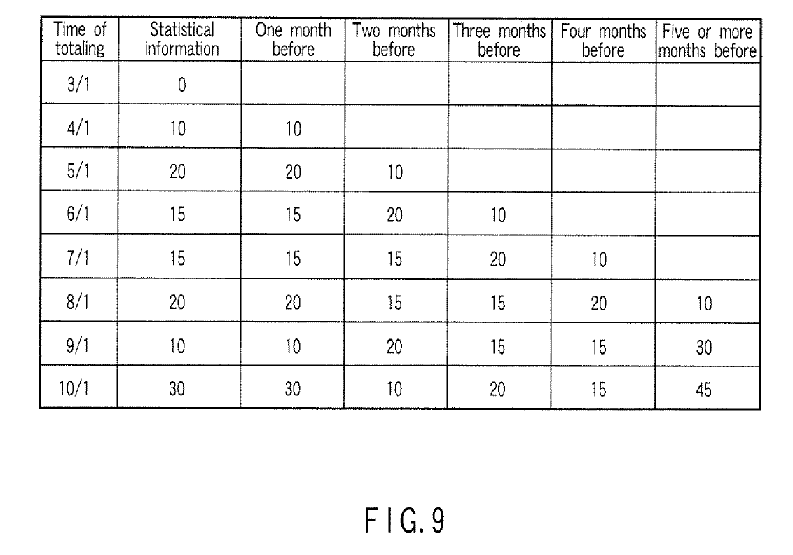

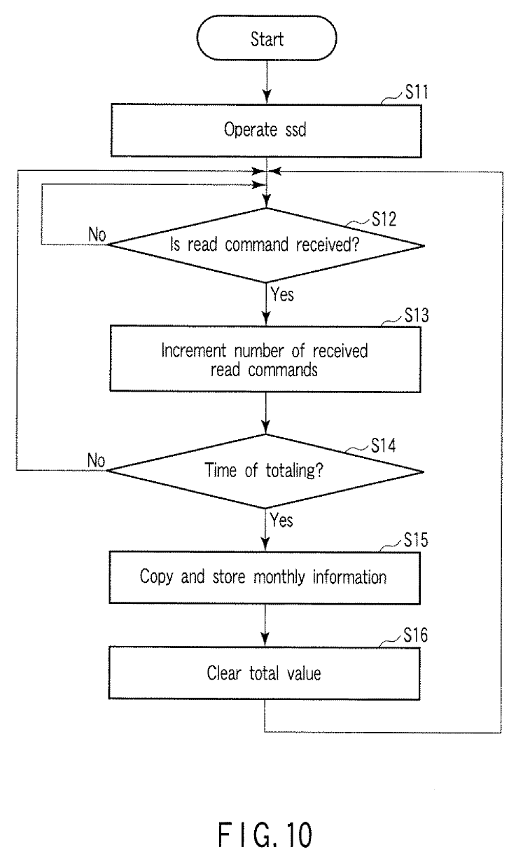

FIG. 9 schematically shows another example of the content of stored monthly information, and FIG. 10 is a flow chart showing another example of the procedure of storing monthly information.

If the SSD 10 starts operating on March 1 (step S11), the control unit 103 increments the number of received read commands (step S13) each time a read command is received (step S12: Yes). When April 1, which is one month after, and is a time of totaling, has come (step S14: Yes), the number of received read commands at that time point, for instance, “10”, is copied and stored as monthly information in the area corresponding to one month before (step S15). Subsequently, the control unit 103 clears the total value which is obtained during the period from the previous time of totaling to the present time of totaling (step S16).

Specifically, the control unit 103 starts monitoring the number of received read commands from March 1, and counts the number of read commands that are received from the host apparatus 8. When April 1 has come, to be more specific, if the total working time of the SSD 10 from the first activation time (March 1) has reached 160 hours, the control unit 103 acquires a count value of the number of received read commands, generates monthly information including this count value (“10”), and stores the generated monthly information in the memory area which is prepared in the NAND memory and which corresponds to monthly information one month before. In addition, the control unit 103 clears the count value of the number of received read commands.

The control unit 103 repeats the above-described process of steps S12 to S14. When May 1, which is two months after, has come (S14: Yes), the control unit 103 stores the number of received read commands, e.g. “20”, as monthly information in the area corresponding to one month before, and stores the number of received read commands, “10”, in the area corresponding to two months before (step S15). In addition, the control unit 103 clears the current total value “20” of the number of received read commands (step S16).

Specifically, the control unit 103 starts monitoring, once again, the number of received read commands from April 1, and counts the number of read commands that are received from the host apparatus 8 after April 1. When May 1 has come, to be more specific, if the total working time of the SSD 10 from the previous generation of monthly information has reached 160 hours, the control unit 103 acquires once again a count value of the number of received read commands, and generates monthly information including this count value (“20”). The control unit 103 shifts the monthly information (“10”), which is already stored in the memory area corresponding to monthly information one month before, to the memory area corresponding to monthly information two months before, and stores the generated monthly information (“20”) in the memory area corresponding to monthly information one month before. Then, the control unit 103 clears the count value of the number of received read commands.

Subsequently, the above-described operation is repeated at each time of totaling, that is, at predetermined time intervals. As a result, the monthly information of the recent five months is stored in the NAND memory.

The memory area corresponding to the monthly information five months before may store only the number of received read commands, which corresponds to the time period of one month which is five months before. Alternatively, as shown in FIG. 9, the memory area corresponding to the monthly information five months before may store the number of received read commands during the entire time period of five months or more before.

As has been described above, after the monthly information is stored in the NAND memory, 104A to 104H, at each time of totaling, the total value (count value) of the number of received read commands is cleared. Thereby, it becomes possible to easily understand how many read commands have been received in one month, which is a predetermined time period. In the above-described example, only the number of received read commands has been described. Actually, monthly information including statistical amounts relating to various object items of monitoring, which have been described with reference to FIG. 6, is stored in the NAND memory in every predetermined time period. In this way, in the present embodiment, the statistical amounts relating to various object items of monitoring are generated as monthly information in every predetermined time period, and the monthly information corresponding to a plurality of periods (e.g. five months) each having the same time period is individually stored in the NAND memory. Thereby, at a time of diagnosing a fault of the SSD 10, for example, it is possible to quickly understand how the SSD 10 has been used immediately before the fault, and to improve the efficiency in analysis work.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
an information processing apparatus main body; and
a nonvolatile semiconductor memory drive which is accommodated in the information processing apparatus main body, the nonvolatile semiconductor memory drive including a nonvolatile semiconductor memory, and a control module configured to control, in accordance with a command from the information processing apparatus main body, a write operation, a read operation and an erase operation of the nonvolatile semiconductor memory, to generate, in every predetermined time period, statistical information relating to the write operation, the read operation and the erase operation of the nonvolatile semiconductor memory, and to store the statistical information, which corresponds to each of a plurality of time periods each having a time length corresponding to the predetermined time period, in a memory area of the nonvolatile semiconductor memory.

2. The information processing apparatus of claim 1, wherein the control module further generates lifetime statistical information relating to the write operation, the read operation and the erase operation of the nonvolatile semiconductor memory, which have been executed from a first activation time of the nonvolatile semiconductor memory drive to a present time point, and stores the generated lifetime statistical information in a memory area of the nonvolatile semiconductor memory, which is different from the memory area in which the statistical information corresponding to the plurality of time periods is stored.

3. The information processing apparatus of claim 1, wherein the statistical information, which is generated in each predetermined time period, includes information relating to numbers of times of the write operation, the read operation and the erase operation, which are executed in the predetermined time period.

4. The information processing apparatus of claim 1, wherein the statistical information, which is generated in each predetermined time period, is indicative of at least a number of write commands and a number of read commands, which are received from the information processing apparatus main body in the predetermined time period, and a number of blocks in the nonvolatile semiconductor memory, which are erased in the predetermined time period.

5. A nonvolatile semiconductor memory drive which is used as an external storage device of an information processing apparatus, comprising:
a nonvolatile semiconductor memory; and
a control module configured to control, in accordance with a command from the information processing apparatus, a write operation, a read operation and an erase operation of the nonvolatile semiconductor memory, to generate, in every predetermined time period, statistical information relating to the write operation, the read operation and the erase operation of the nonvolatile semiconductor memory, and to store the statistical information, which corresponds to each of a plurality of time periods each having a time length corresponding to the predetermined time period, in a memory area of the nonvolatile semiconductor memory.

6. The nonvolatile semiconductor memory drive of claim 5, wherein the control module further generates lifetime statistical information relating to the write operation, the read operation and the erase operation of the nonvolatile semiconductor memory, which have been executed from a first activation time of the nonvolatile semiconductor memory drive to a present time point, and stores the generated lifetime statistical information in a memory area of the nonvolatile semiconductor memory, which is different from the memory area in which the statistical information corresponding to the plurality of time periods is stored.

7. The nonvolatile semiconductor memory drive of claim 5, wherein the statistical information, which is generated in each predetermined time period, includes information relating to numbers of times of the write operation, the read operation and the erase operation, which are executed in the predetermined time period.

8. The nonvolatile semiconductor memory drive of claim 5, wherein the statistical information, which is generated in each predetermined time period, is indicative of at least a number of write commands and a number of read commands, which are received from the information processing apparatus in the predetermined time period, and a number of blocks in the nonvolatile semiconductor memory, which are erased in the predetermined time period.
